(19) United States
(12) Patent Application Publication
(10) Pub. No.: US 2023/0295371 A1
(43) Pub. Date: Sep. 21, 2023

(54) MEMBRANE FABRICATION OF QUATERNARY AMMONIUM FUNCTIONALIZED POLYPHENYLENE POLYMERS BY GREEN SUSTAINABLE ORGANIC SOLVENTS

(71) Applicant: Advent Technologies Holdings, Inc., Boston, MA (US)

(72) Inventors: Christos L. Chochos, Ilion, Athens (GR); George Paloumbis, Patras (GR); Cynthia Lemay Olson, Chelmsford, MA (US)

(21) Appl. No.: 17/700,087

(22) Filed: Mar. 21, 2022

(51) Int. Cl. C08G 61/10; B29C 41/00; B29C 41/02

(52) U.S. Cl. CPC C08G 61/10; B29C 41/003; B29C 41/02; B29K 2065/00; B29L 2031/755

(57) ABSTRACT

The invention relates to the fabrication of membranes based on polyphenylene-based polymers—and more particularly, for example, quaternary ammonium functionalized polyphenylene-based polymers—utilizing a class of green sustainable organic solvents, such as cyclic ketones, by casting or coating for use in high temperature polymer electrolyte membrane fuel cells or water electrolyzers.

### FIELD OF INVENTION

The invention relates to the synthesis of polyphenylene-based polymers and more particularly, for example, to quaternary ammonium functionalized polyphenylene-based polymers, and to the fabrication of membranes thereof, by utilizing a class of green sustainable organic solvents, such as cyclic ketones, through casting or coating for use in high temperature polymer electrolyte membrane fuel cells or water electrolyzers.

### DESCRIPTION OF THE RELATED ART

Fuel cells are promising devices for clean power generation in a variety of economically and environmentally significant applications. By using hydrogen produced from renewable energy sources, such as solar and wind, fuel cells can provide carbon-neutral power without any pollutants, such as SOₓ and NOₓ. Initial commercialization of clean, high-efficiency fuel cell electric vehicles is already underway, but further technological innovation is needed to improve cost-competitiveness of fuel cells in the marketplace.

Currently, there are two general types of fuel cells: low temperature fuel cells and high temperature fuel cells. Low-temperature proton exchange membrane (PEM) fuel cells utilizing Nafion® polymeric materials for membranes require a high level of hydration, which limits the operating temperature to less than 100° C. to preclude excessive water evaporation. The structure for Nafion® is provided below.

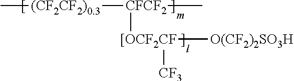

Low-temperature PEM fuel cells that use Nafion® are currently being commercialized in fuel cell vehicles, but these cells can operate only at relatively low temperatures and high hydration levels; therefore, they require humidified inlet streams and large radiators to dissipate waste heat.

In contrast, high-temperature PEM fuel cells typically utilize membranes comprising phosphoric acid-doped polybenzimidazole, shown below.

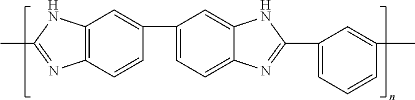

High temperature fuel cells can operate effectively up to 180° C.; however, these devices degrade when exposed to water below 120° C., and especially when below 100° C. High-temperature PEM fuel cells that use phosphoric acid (PA)-doped polybenzimidazole (PBI) could address these issues, but these PBI-based cells are difficult to operate below 140° C. without excessive loss of PA. The limited operating temperature range makes them unsuitable for automotive applications, where water condensation from frequent cold start-ups and oxygen reduction reaction at the fuel cell cathode occur during normal vehicle drive cycles.

Quaternary ammonium (QA) functionalized polymers are known, and some have been developed for alkaline electrochemical devices. As currently understood, phosphoric acid-doped QA functionalized polymers have been reported only once, by the Wegner research group at Max Planck Institute in 1999, (A. Bozkurt et al., Proton-conducting Polymer Electrolytes based on Phosphoric Acid, Solid State Ionics, 125, 225 (1999)). Bozkurt et al. used poly(diallyldimethylammonium) as the polymeric material used to produce the fuel cell membrane, and their approach was substantially the same as that of the PA-doped PBI in three respects: 1) the quaternary ammonium moiety of the synthesized polymer was located within the polymer backbone; 2) the quaternary ammonium moiety concentration was high (about 7.2 mmol/gram, which is comparable to that of PBI, about 6.5 mmol/gram); and 3) the researchers were primarily interested in anhydrous proton conductivity.

Currently, QA functionalized polyphenylenes are considered the state-of-the-art polymeric materials for low temperature and high temperature fuel cells, shown below.

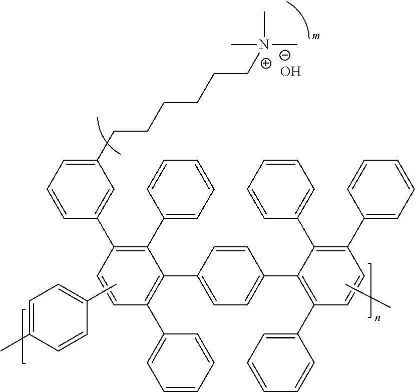

Due to the possibility of forming entirely aromatic backbone polymers (J. Stille, et al., Diels-Alder polymerizations: Polymers containing controlled aromatic segments, Journal of Polymer Science Part B:Polymer Letters, 4, 791 (1966)), poly(phenylene)s made by Diels-Alder polymerization (DAPP) have been demonstrated to be suitable for polymer electrolyte membranes. With the further QA functionalization DAPP-based ion exchange membrane was first utilized as anion exchange membranes before being utilized in high temperature polymer electrolyte membrane fuel cell (C. H. Fujimoto et al., Ionomeric Poly(phenylene) Prepared by Diels-Alder Polymerization: Synthesis and Physical Properties of a Novel Polyelectrolyte Macromolecules, 38, 5010 (2005)).

However, the QA functionalized polyphenylene shown above along with its precursor polymer derivatives are formed into membranes upon casting from chlorinated non aromatic solvents, such as chloroform or dichloromethane. From an industrial manufacturing point of view the chlorinated non aromatic solvents are prohibitively expensive to use since some are suspected carcinogens, cannot be released to the environment, and must be completely eliminated through oxidative combustion. Thus, these solvents cannot be used for large scale membrane manufacturing in industrial environments.

### SUMMARY OF THE INVENTION

The invention provides, inter alia, novel methods for fabricating quaternary ammonium functionalized polyphenylene-based polymer membranes, e.g., for use in polymer electrode membrane (PEM) fuel cells and water electrolyzers.

Thus, for example, according to one aspect, the invention provides a method for forming a solution by dissolving poly(phenylene)-based polymers in a polar aprotic solvent, and evaporating the polar aprotic solvent from the solution to form a polyphenylene-based membrane.

Such a polyphenylene-based polymer is a quaternary ammonium functionalized polyphenylene-based polymer, comprising a poly(phenylene) backbone with about 25 to 200 repeat units, and six pendant phenyl(aryl) rings at least one of which includes a side chain consisting of a monovalent hydrocarbon group of two to 18 carbon atoms terminated by a quaternary ammonium group.

According to further aspects of the invention, the polar aprotic solvent comprises cyclic ketones of the general formula

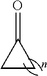

where n is an integer between 1 to 20, inclusive.

In related aspects of the invention, the polar aprotic solvent comprises any of n-methyl pyrrolidone, dimethyl acetamide, dimethyl sulfoxide, dimethyl formamide, acetonitrile and ethyl acetate.

Still further related aspects of the invention provide methods, e.g., as described above, in which the solvent comprises a mixture of two or more of the aforesaid cyclic ketones and/or other polar aprotic solvents.

Still further aspects of the invention comprise a method as described above that additionally include forming a polyphenylene-based polymer membrane and more particularly, by way of example, an alkylketo, an alkyl or a quaternary ammonium functionalized polyphenylene-based polymer membranes, by any of coating and casting the aforesaid solution. This can include, according to a related aspect of the invention, casting the solution into a flat surface to allow the solvent to evaporate. Alternatively, it can include forming the membrane by any of doctor blade coating, slot die coating, gravure printing, and roll to roll printing.

Methods according to the invention can, in still further aspects, include synthesizing polyphenylene-based polymers, e.g., for use in polymer electrode membrane fuel cells and/or water electrolyzers, in accord with the methods described above.

Additional aspects, features and benefits of the present invention will become apparent from the detailed description, figures, and claims set forth below.

### BRIEF DESCRIPTION OF THE DRAWINGS

FIG. 1 shows a scheme for attachment of side chains to a Diels-Alder polyphenylene polymer (DAPP) using chlorinated solvents.

FIG. 2 shows another scheme for forming compositions with side chain chemistry using chlorinated solvents.

FIG. 3 depicts polyphenylene-based polymers and, more particularly, quaternary ammonium functionalized polyphenylene-based polymers synthesized according to the invention using a non-chlorinated solvent, cyclopentanone, and cast as membranes according to the invention, e.g., for polymer electrolyte membrane fuel cells or water electrolyzers applications.

FIGS. 4-5 show synthesis of polyphenylene-based polymers according to the invention using non-chlorinated solvents.

### DETAILED DESCRIPTION OF THE INVENTION

The present invention relates to the use of alternative organic solvents to synthesize the polymer shown and described below and its precursor polymer derivatives for membrane formation, e.g., for polymer electrolyte membrane fuel cells or water electrolyzers (by way of non-limiting example), in a manner compatible with industrial manufacturing restrictions.

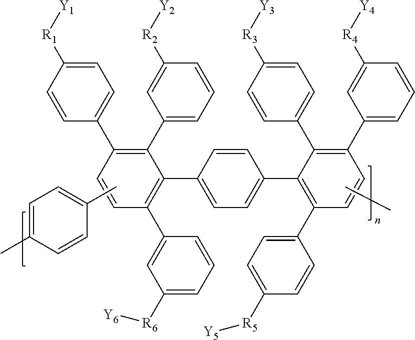

The polymer is consisting of a poly(phenylene) backbone with about 25 to 200 repeat units. The polymer is synthesized by various methods including Diels Alder reactions for example where bis-tetraphenylcyclopetadienone reacts with p-bis(ethynyl)benzene to yield carbon monoxide and a polyphenylene with a mix of meta and para configurations imparted by the selectivity of a Diels-Alder polymerization. Furthermore, the polymer includes six phenyl(aryl) rings, wherein at least one of the phenyl rings includes a side chain including a monovalent hydrocarbon group of two to 18 carbon atoms. The pendant phenyl groups provide for the introduction of up to six hydrocarbon groups terminated by a quaternary ammonium group. For ease of explanation, a polyphenylene polymer will be referred to herein as DAPP referencing the Diels-Alder method of synthesis. The compositions described herein may also be referred to as a substituted DAPP or a polyphenylene-based polymer or, more particularly, a quaternary ammonium functionalized polyphenylene-based polymer.

For example, synthesis of DAPPs are performed using a modification of the method known in the art wherein to bis-tetracyclone (50.0 g; 72.4 mmol) and 1,4-diethynylbenzene (9.13 g; 72.4 mmol) in a 500 mL Schlenk flash, diphenyl ether (250 mL) is added and the resulting mixture is frozen in an ice bath. The mixture is freeze-thaw degassed (3.times.) before heating under argon at 180° C. for 48 h. The reaction vessel is then cooled to room temperature and its contents are diluted with toluene (300 mL). The polymer is precipitated by dropwise addition of the solution to 1000 mL of acetone. This dilution in toluene and precipitation in acetone is repeated and the resultant white solid is dried in a vacuum oven for 12 h at 80° C., 48 h at 230° C., and 24 h at room temperature. A 96% yield (52 g collected) of a tough, yellow solid is obtained. According to one embodiment of the present invention, the DAPP polymer is polymerized in the absence of a metal catalyst.

In the embodiment, the pendant phenyl groups provides for the introduction of up to six side chains, indicated as R₁-R₆. Each of R₁-R₆ is a hydrogen (H) or a monovalent hydrocarbon group including two to 18 carbon atoms that may be the same or different with the proviso that each of R₁-R₆ cannot be H. A monovalent hydrocarbon group may have a straight chain or a branched chain structure and may be saturated or unsaturated. Unsaturated monovalent hydrocarbon groups have one or more double bonds, one or more triple bonds, or combinations thereof. A monovalent hydrocarbon group may be substituted with one or more hydroxyl groups (—OH), oxo groups (═O), and substituted or unsubstituted amine groups. A straight or branched chain of a monovalent hydrocarbon group may also be interrupted by O, N, or S atoms.

One or more side chains R₁-R₆ can include a functional group, indicated as Y₁-Y₆ that may each be the same or different. A functional group Y₁-Y₆ may be attached as a pendant group anywhere in a chain of a monovalent hydrocarbon group. In one embodiment, a functional group Y₁-Y₆ is attached at the end of the chain. A functional group is selected to impart a desired property to a DAPP polymer, including rendering a functional group susceptible to substitution with another functional group. One example of a functional group is a functional group that is a cationic group. As noted above, polymers including pendant cationic groups have found use in anion exchange membranes employed in both fuel cells and electrolyzers. The ammonium functionality is an example of a cationic group.

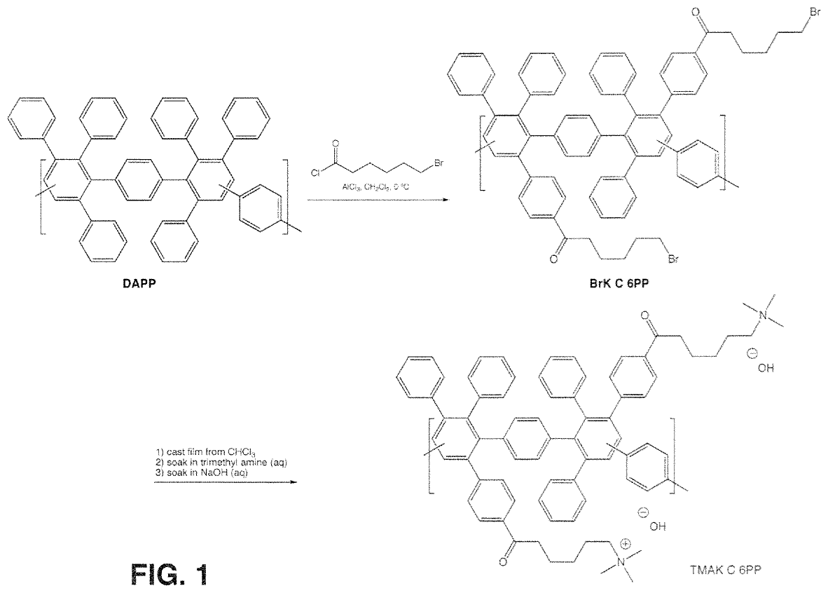

FIG. 1 shows an embodiment of a scheme for attachment of side chains to a DAPP. In one embodiment, the side chains are attached using a Friedel-Crafts acylation reaction. Since none of the pendant phenyl rings in the DAPP is deactivated, the acylation could take place on any of the phenyl rings. The peripheral phenyl rings are the most accessible and therefore the most likely points of attachment. Referring to FIG. 1, in this embodiment, a side chain of a monovalent hydrocarbon group including six carbon atoms including an acyl group and initially having a halogen functional group (bromine) at the end of the chain is attached to two different pendant phenyl rings of the DAPP molecule. According to a Friedel-Crafts acylation process, the attachment is carried out by reacting an acyl chloride (6-bromohexanoyl chloride) with the DAPP resulting in the structure identified as BrKC6PP. Although only two side chains are illustrated attached to the DAPP, it is appreciated that the number of side chains is controlled by the amount of acylating reagent used so polymers with varying degrees of functionalization can be prepared. Also, only one acylation reaction can occur per ring because the resulting attached acyl group (ketone) deactivates the ring.

Following the formation of BrKC6PP, the halogen functional group is substituted with a nitrogen-containing base. FIG. 1 shows a DAPP including a functional group that is an ammonium group identified as TMAKC6PP.

Details of a process for forming BrKC6PP and TMAKC6PP by casting are presented in Example 1.

### Example 1

Synthesis of BrKC6PP. DAPP (1.73 g, 2.28 mmol) was dissolved in dichloromethane (110 mL) in a flask under argon. The flask was chilled in an ice/water bath and 6-bromohexanoyl chloride (0.80 mL, 5.35 mmoles) was added. Aluminum chloride was added to the flask, the bath was removed, and the reaction was allowed to warm to room temperature over 5 hours while stirring. The solution was poured into a beaker containing 200 mL deionized water and the beaker was heated to 60° C. to evaporate the organic solvent. After cooling to room temperature, the mixture was filtered and the solid was blended with acetone in a Waring blender. The mixture was filtered and the solid was dried at room temperature under vacuum to yield DAPP with a bromohexonyl side chain/functional group identified as BrKC6PP as an off-white solid (2.28 g, 85%).

Synthesis of TMAKC6PP. A solution of BrKC6PP (440 mg) in chloroform (10 mL) was filtered through a syringe filter into a circular glass dish with a 3.75 inch diameter. An inverted beaker was placed over the dish and the solvent was allowed to evaporate over 18 h. The resulting film was removed from the dish and immersed in a trimethylamine solution (50 wt % in water) for 48 hours. The resulting membrane was then immersed in 0.5 M HBr for 2 hours and then in deionized water for at least 24 hours to yield DAPP with a trimethyllaminohexanoyl side chain/functional group identified as TMAKC6PP in its bromide counterion form.

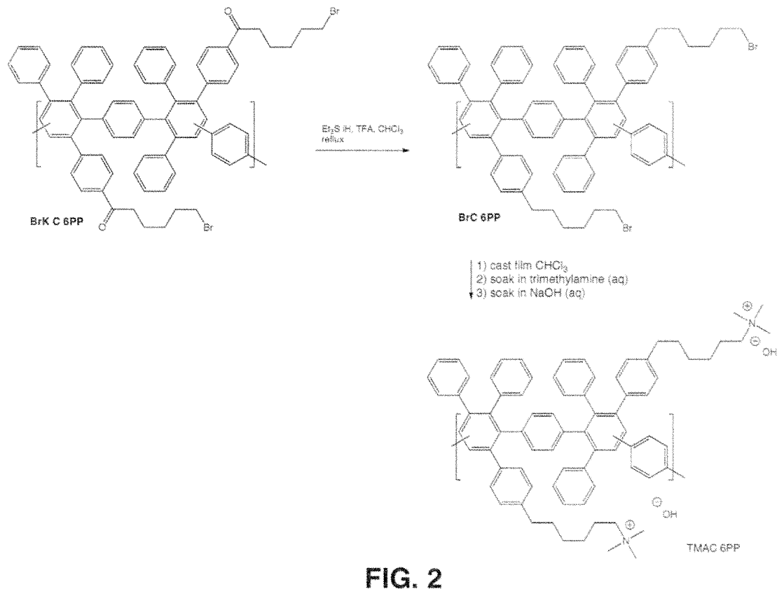

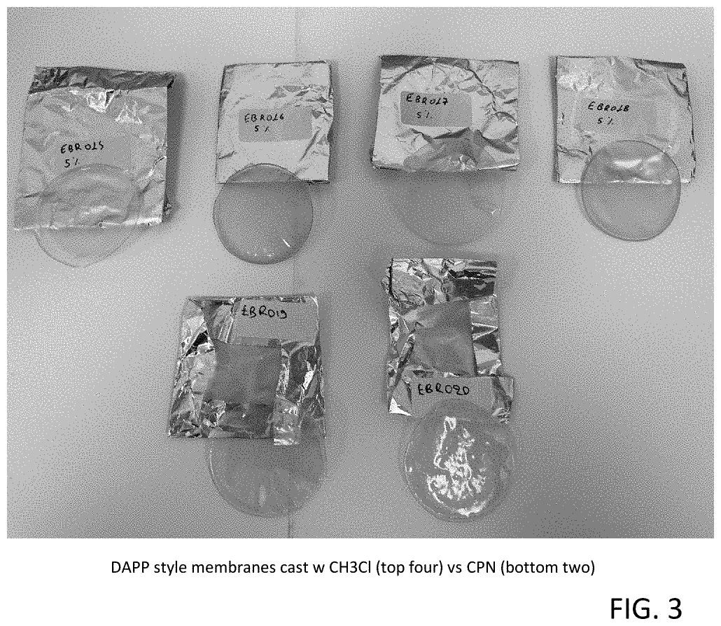

FIG. 2 shows the synthetic scheme for one other composition based on the flexible sidechain chemistry. The polymer is prepared in two steps. The first step is a reduction of the ketones or acylated side chains in BrKC6PP to form DAPP with alkyl side chains, identified as BrC6PP. The second step is a substitution of the bromine atom with trimethylamine to form alkyl trimethylammonium groups. The resulting membrane, identified as TMAC6PP, is similar to TMAKC6PP except that the ketone has been reduced.

Details of a process for forming BrC6PP and TMAC6PP by casting are presented in Example 2.

### Example 2

Synthesis of BrC6PP. To a solution of BrKC6PP (1.50 g, 1.16 mmol)) in chloroform (40 mL) was added trifluoroacetic acid (20 mL) and triethylsilane (1.90 mL, 11.91 mmol). The solution was heated to reflux for 24 hours, then cooled to room temperature and poured into a beaker containing NaOH (9.6 g) dissolved in water (300 mL). The beaker was heated to 60° C. to evaporate the organic solvent. After cooling to room temperature the mixture was filtered and the solid was blended with acetone in a Waring blender. The mixture was filtered and the solid was dried at room temperature under vacuum. Analysis of this product indicated incomplete reduction of the ketone, so the solid was dissolved again in chloroform (40 mL) and trifluoroacetic acid (20 mL) and triethylsilane (1.90 mL, 11.91 mmol) were added. The solution was heated to reflux for 24 hours, then cooled to room temperature and poured into a beaker containing NaOH (9.6 g) dissolved in water (300 mL). The beaker was heated to 60° C. to evaporate the organic solvent. After cooling to room temperature, the mixture was filtered and the solid was blended with acetone in a Waring blender. The mixture was filtered and the solid was dried at room temperature under vacuum to yield BrC6PP as a white solid (1.30 g, 89%).

Synthesis of TMAC6PP. A solution of BrC6PP (1.20 g) in chloroform (30 mL) was filtered through a syringe filter into a square glass dish with 5-inch edges. An inverted beaker was placed over the dish and the solvent was allowed to evaporate over 18 h. The resulting film was removed from the dish and immersed in a trimethylamine solution (50 wt % in water) for 48 hours. The resulting membrane was then immersed in 0.5 M HBr for 2 hours and then in deionized water for at least 24 hours to yield the TMAC6PP composition in its bromide counterion form.

As shown above, for the synthesis of TMAC6PP or TMAKC6PP, the precursor polymers BrC6PP and BrKC6PP, respectively are dissolved in chloroform solution and filtered through a syringe filter into a circular glass dish to form the membrane before soaking them in aqueous trimethylamine.

The high aromaticity and molecular weight combined with functionalized charged groups leads to numerous challenges in finding a solvent to adequately dissolve the polymer. Typically, chlorinated solvents possess the right mix of charge and organic solubility, and for this class of polymers, only chlorinated solvents have been employed. However, the use of chlorinated non aromatic solvents, such as chloroform or dichloromethane are prohibited and cannot be used for large scale membrane manufacturing at industrial environments.

Surprisingly, alternative solvents for the fabrication of BrC6PP- or BrKC6PP-based membranes are polar aprotic solvents, such as by way of example n-methyl pyrrolidone (NMP), dimethyl acetamide (DMAc), dimethyl sulfoxide (DMSO), dimethyl formamide (DMF), acetonitrile and ethyl acetate. Other suitable polar aprotic solvents include, cyclopentanone (CPN) and cyclohexanone (CHN) and, more generally, cyclic ketones of the general formula

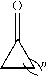

where n is an integer between 1 to 20, inclusive. For example, when n=1 is cyclopropenone; n=2 is cyclobutanone; n=3 is cyclopropanone; n=4 cyclohexanone; etc. Still other suitable solvents comprise a mixture of two or more of the aforesaid cyclic ketones and/or other polar aprotic solvents.

Cyclopentanone (CPN) and cyclohexanone (CHN) are readily derived from renewable biomass resources that are attractive in future green and sustainable chemical processes. While both cyclopentanone and cyclohexanone have been proposed for use as biofuels and fine chemicals, they are also suitable as molecular solvents for industrial because they have high KamletTaft (KT) dipolarity/polarizability (π*≈0.78), moderately-high KT basicity (β≈0.54) and low KT acidity (α≈0).

Details of a process for forming BrC6PP and BrKC6PP membranes by casting are presented in Example 3.

### Example 3

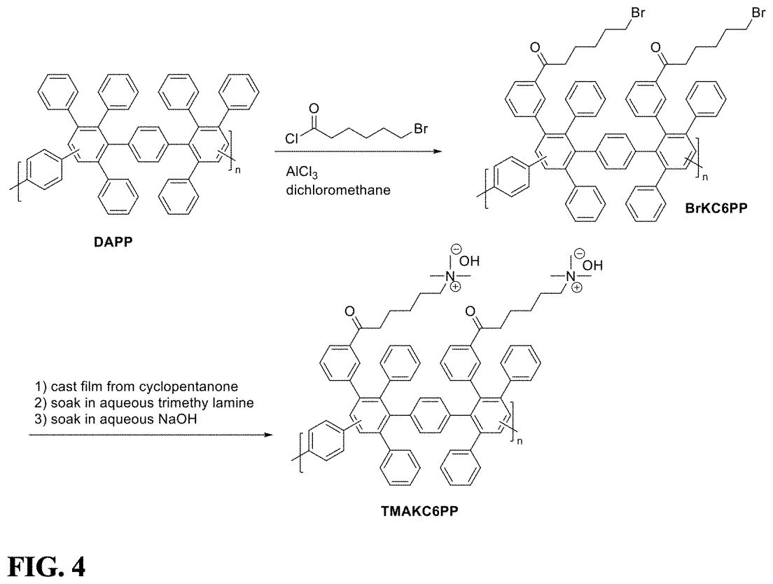

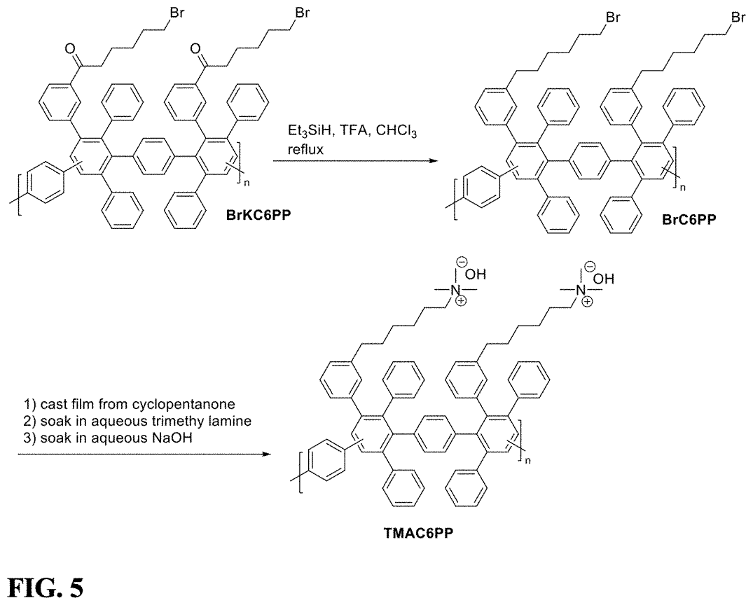

Synthesis of TMAC6PP or TMAKC6PP by CPN as green and sustainable solvent. A solution of BrC6PP or BrKC6PP (1.20 g) in CPN (30 mL) was filtered through a syringe filter into a square glass dish with 5-inch edges. An inverted beaker was placed over the dish and the solvent was allowed to evaporate over 18 h. The resulting film was removed from the dish and immersed in a trimethylamine solution (50 wt % in water) for 48 hours. The resulting membrane was then immersed in 0.5 M HBr for 2 hours and then in deionized water for at least 24 hours to yield the TMAC6PP or TMAKC6PP composition in its bromide counterion form. FIGS. 4-5 depict synthesis of TMAKC6PP and TMAC6PP membranes, respectively, using the non-chlorinated solvent cyclopentanone, as discussed above.

Membranes formed, e.g., in accord with Example 3, above, can be shaped, sized or otherwise adapted for use in polymer electrode membrane fuel cells and water electrolyzers, among other applications, all as is within the ken of those skilled in the art in view of the teachings hereof.

Described above are the utilization of new green sustainable organic solvents for fabricating membranes based on polyphenylene-based polymers—and more particularly, for example, quaternary ammonium functionalized polyphenylene-based polymers—with industrial compatible manufacturing processes, e.g., for use in polymer electrode fuel cells and water electrolyzers. It will be appreciated that the techniques described above are examples and that other embodiments incorporating changes thereto fall within the scope of the invention. Thus, by way of non-limiting example, rather than forming the polyphenylene-based polymer membranes by casting, coating techniques can be employed instead. This includes by way of example doctor blading, slot die coating, gravure printing, and roll to roll printing, the application of which coating techniques is within the ken of those skilled in the art in view of the teachings hereof

What is claimed is:

1. A method for fabricating polyphenylene-based membranes comprising:
A. forming a solution by dissolving poly(phenylene) in a polar aprotic solvent, and
B. evaporating the polar aprotic solvent from the solution to form a polyphenylene-based membrane.

2. The method of claim 1, where the polyphenylene-based membrane is a quaternary ammonium functionalized polyphenylene-based polymer that comprises a poly(phenylene) backbone with about 25 to 200 repeat units, and six pendant phenyl(aryl) rings at least one of which includes a side chain consisting of a monovalent hydrocarbon group of two to 18 carbon atoms terminated by a quaternary ammonium group.

3. The method of claim 1, wherein the polar aprotic solvent comprises cyclic ketones of the general formula 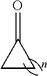
where n is an integer between 1 to 20, inclusive.

4. The method of claim 1, wherein the polar aprotic solvent comprises any of n-methyl pyrrolidone, dimethyl acetamide, dimethyl sulfoxide dimethyl formamide, acetonitrile and ethyl acetate.

5. The method of claim 1, wherein the polar aprotic solvent comprises a mixture of two or more of a cyclic ketone and any of n-methyl pyrrolidone, dimethyl acetamide, dimethyl sulfoxide dimethyl formamide, acetonitrile and ethyl acetate.

6. The method of claim 1, comprising forming the polyphenylene-based membrane by any of coating and casting the solution.

7. The method of claim 6, comprising forming the polyphenylene-based membrane by casting the solution into a flat surface to allow the solvent to evaporate.

8. The method of claim 6, comprising forming the polyphenylene-based membrane by any of doctor blade coating, slot die coating, gravure printing, and roll to roll printing.

9. The method of claim 6, comprising forming the polyphenylene-based membrane for use in high-temperature polymer electrode membrane fuel cells.

10. The method of claim 6, comprising forming the polyphenylene-based membrane for use in water electrolyzers.

11. A method for synthesis of polyphenylene-based polymers comprising:
A. forming a solution by dissolving poly(phenylene) in a polar aprotic solvent, and
B. evaporating the polar aprotic solvent from the solution to form a polyphenylene-based polymer.

12. The method of claim 1, where the polyphenylene-based polymer is a quaternary ammonium functionalized polyphenylene-based polymer that comprises a poly(phenylene) backbone with about 25 to 200 repeat units, and six pendant phenyl(aryl) rings at least one of which includes a side chain consisting of a monovalent hydrocarbon group of two to 18 carbon atoms terminated by a quaternary ammonium group.
